(19) United States
(12) Patent Application Publication
(10) Pub. No.: US 2023/0268809 A1
(43) Pub. Date: Aug. 24, 2023

(54) Power Box Generator

(71) Applicant: Joseph Chruscinski, Satsuma, FL (US)

(72) Inventor: Joseph Chruscinski, Satsuma, FL (US)

(21) Appl. No.: 17/678,100

(22) Filed: Feb. 23, 2022

(51) Int. Cl. H02K 11/30; H02J 7/00

(52) U.S. Cl. CPC H02K 11/30; H02J 7/0063

(57) ABSTRACT

The device will provide limited power generation in a self-contained unit that will be used for temporary purposes. A battery that produces direct current will be installed. The direct current will be converted to alternating current to power devices that depend on alternating current. An inverter circuit is provided to make the necessary conversion from direct current to alternating current that is required to provide power to devices that use alternating current.

### PRIOR ART

This is an application that will provide temporary power that is pollution free power in the event of an emergency. It will operate off a battery and it is intended to replace a portable generator, which typically pollutes and is noisy. A representative example of this type of device in the prior art can be found at Kimura, U.S. Pat. No. 8,587,220, which is a power converter. This however, is just simply a converter; it is not an energy source.

Another example in the prior art can be found at Proud, U.S. Pat. No. 8,803,366. This is a wireless power receiver including a rectifier coupled to an antenna; however, this is not a temporary energy source. Other examples of prior art include Itoh, U.S. Pat. No. 884,565, Fuller, U.S. Pat. No. 9,231,5504; Abe, U.S. Pat. No. 266,441 and Broussard, U.S. Pat. No. 9,270,119. None of the prior art references discuss or teach a power generator system, which is operated by a battery.

### FIELD OF THE INVENTION

This device is a generator that has been designed for emergency purposes and for safe operation in any conditions. This is not meant to replace the electrical system of a home or business but is meant to provide temporary safe energy on a limited basis without the need for a portable generator, which pollutes and is noisy. Power is derived from a direct current battery and converted into alternating current that can be used in the home to power various appliances that are commonly found in the home. This device will not emit exhaust and is quiet.

### BRIEF SUMMARY OF THE INVENTION

The device will convert direct current power into alternating current to provide power for some, but not all the appliances, that are found in the typical home. It is designed to be portable and will not emit any exhaust. Because electric current is converted from a battery to alternating current, with no moving mechanical parts other than a plurality of cooling fans, it will be relatively quiet and completely pollution free.

A 12 volt (12V) battery will be connected to a terminal block generator in a closed circuit system running on a 12-volt circuit. The output of the circuit is between 120 and 240 volts depending on the configuration of the building that is to be powered. Most household appliances and fixtures use 120 volts, so it is likely that most of the units will be configured for in 120 volts. This unit is completely self-contained, requiring no external charging systems and will be compromised of various components: a battery, transistors, electric board, resistors, cooling fans, switch, outlet, transformer, and LED indicator light. The device would convert 12 volts into 120 volts to run a home on a temporary basis.

It is designed to be stored easily, lightweight, and portable. It is estimated that the device with a box in which all the components are housed would weigh approximately eight to ten pounds. It can be easily moved from location to location and can be installed quickly and easily.

### BRIEF DESCRIPTION OF THE DRAWINGS

FIG. 1 is an isometric view of the schematic diagram.

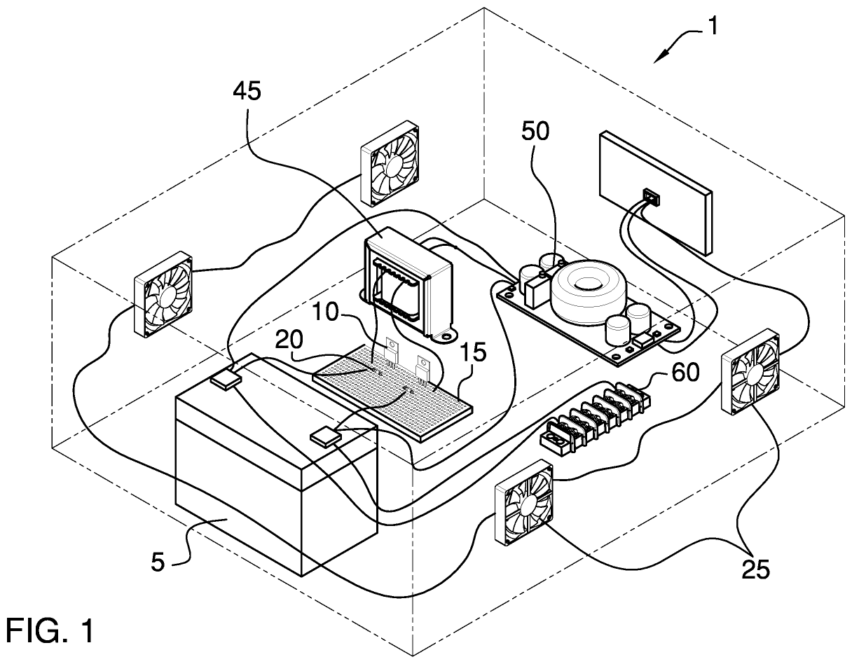

FIG. 2 is an end view of the device depicting the connection ports for the device.

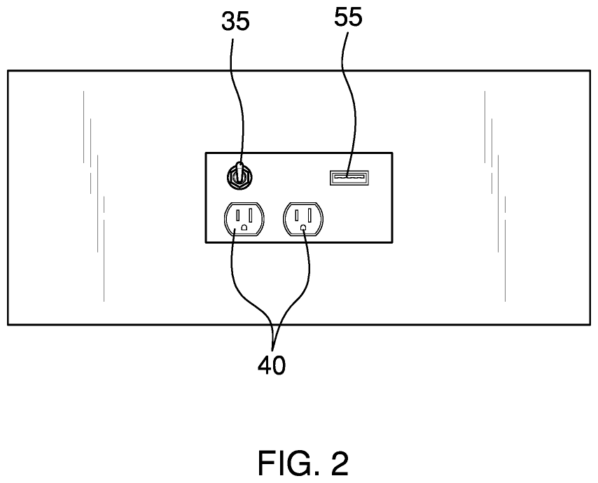

FIG. 3 is a block diagram of the components of the device.

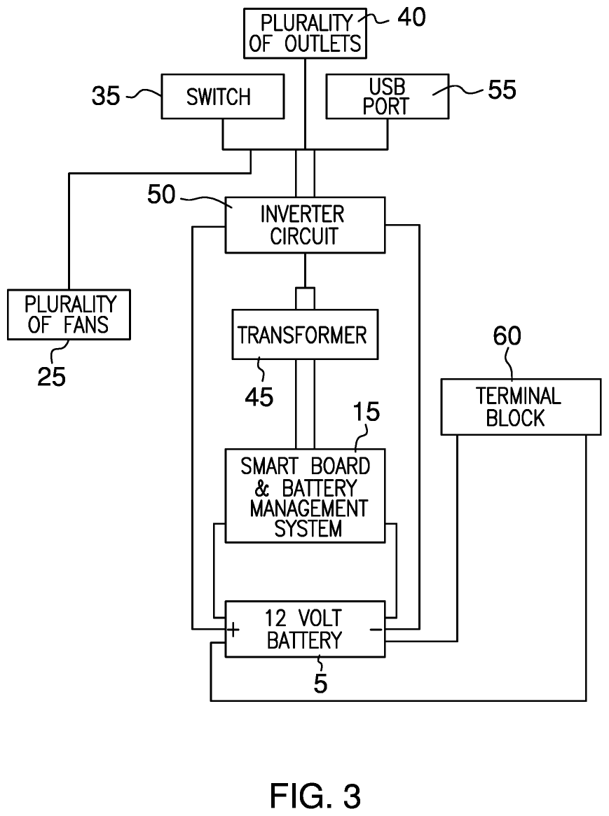

### NUMBERING REFERENCES

1 Device
5 Battery
10 Transistors
15 Electric board
20 Resistors
25 Cooling fans
30 LED indicator light
35 Switch
40 Outlet
45 Transformer
50 Inverter Circuit
55 USB Port

### DETAILED DESCRIPTION OF THE EMBODIMENTS

The device 1 will be housed in a self-contained unit. An access panel will be provided to access the components of the unit. All the components will be contained in a single container or box.

A 12 volt battery 5 is connected to an electric board 15 which is connected to a transformer 45. The electric board 15 is also connected to the transformer 45. The flow of current from the battery to the transformer would travel from the battery to the electric board that contains a plurality of transistors 10 that are provided to ensure that the electrical flow occurs in one direction. A plurality of resistors 20 are provided on the electrical board to provide a means to regulate the voltage from the battery to the transformer, which increase the direct voltage from the electrical board to the inverter circuit 50 for use in the home.

Since most if not all electrical appliances and fixtures in a home use alternating current an inverter board is installed in the system. The inverter circuit 50 converts the stepped up direct current to alternating current to be used in the home.

This device will generate heat and it is important to cool the components to ensure longevity of the components. A plurality of cooling fans 25 will be installed to keep all the components at a desired temperature.

On the outside of the box will be an LED indicator light 30 which will indicate when the device is being used.

An outlet 40 is provided on the outside of the unit so as the power is generated, the user of the system can plug in any devices to the outlet 40. A USB port 55 is also provided to ensure that access to the internet will be provided.

Additionally, a switch 35 is provided to turn the unit off and on as desired.

Again, this device is designed to be a portable one time use device for emergency purposes that is lightweight, portable and pollution free. It is not designed to power a complete home or business over an extended time.

The inventor claims:

1. A power box generator which is comprised of the following:
a. a box;
wherein all the components of the device are contained within the box;
b. a battery;
wherein the battery provides direct current;
wherein the battery is connected to an electric board;
c. the electrical board;
wherein the electrical board connects the battery to a transformer;
d. a plurality of transistors;
wherein the plurality of transistors ensures one direction electrical flow;
e. a plurality of resistors;
wherein the plurality of resistors regulates the impedance of the current in the electrical board;
f. a plurality of cooling fans;
g. a transformer;
wherein the transformer increases the voltage from the direct current source to the inverter board;
h. inverter circuit;
wherein the inverter circuit is connected to the transformer and the outlet;
wherein the inverter circuit converts the direct current to alternating current;
i. a LED Indicator Light;
j. a switch;
k. an outlet;
l. a USB port.
